(19) United States
(12) Patent Application Publication
(10) Pub. No.: US 2010/0146263 A1
(43) Pub. Date: Jun. 10, 2010

(54) METHOD AND SYSTEM FOR SECURE AUTHENTICATION

(75) Inventors: Tamal Das, Bangalore (IN); Mridula Gera, Bangalore (IN); Suresh Anantpurkar, Bangalore (IN)

Correspondence Address: PEARNE & GORDON LLP, 1801 EAST 9TH STREET, SUITE 1200, CLEVELAND, OH, 44114-3108, US

(73) Assignee: MCHEK INDIA PAYMENT SYSTEMS PVT. LTD., Mumbai (IN)

(21) Appl. No.: 12/665,780

(22) PCT Filed: Jun. 20, 2008
(86) PCT No.: PCT/IN2008/000389

§ 371 Date: Jan. 21, 2010

(30) Foreign Application Priority Data
Jun. 20, 2007 (IN) 1194/MUM/2007

(51) Int. Cl. H04L 29/06

(52) U.S. Cl. 713/155

(57) ABSTRACT

The invention relates to a method of authentication for a provider comprising requesting a verification system for authentication of a transaction initiated by a user by transmitting to the verification system details of the transaction initiated; requesting the user to authenticate the transaction on a mobile device by transmitting to the user mobile device details of the transaction; validating the authentication request received from the verification system on the mobile device and prompting the user to enter a personal identification number, displaying to the user transaction details on receiving a valid personal identification number and requesting user to authenticate transaction; generating on receiving user authentication an authentication parameter for transmission to the verification system; and authenticating the transaction to the provider on receiving a valid authentication parameter from user mobile device.

The invention relates to the field of security, cryptography and authentication. More particularly, the invention relates to a method and system for secure authentication and the generation and verification of one-time-use secure authentication codes.

### DESCRIPTION OF RELATED ART

With the advance of interne based and mobile based commerce and communication, the threat of online fraud has risen significantly. Existing security and authentication methodologies provide restricted access to the protected data or object on the basis of various factors or their combination such as something that the user knows (passwords, PINs, etc), something that the user has (hardware devices) or something that the user is (biometrics).

Something that the user knows refers to anything in the knowledge of the user such as a password, codeword or personal identification number (PIN). Something that the user has, referred to commonly as token, maybe any physical or electronic object that is uniquely identifiable with the user. A physical key for use in a door is an example of is something that the user has or a ‘token’. Tokens may also be microprocessor based devices with a built-in display and a cryptographic key unique to the token. A random and unique one-time-use code is generated by the token that is verified against an expected value by the verifier. Lastly, something that the user is refers to characteristics that are unique to the user such as fingerprints, eye retina or other physical or biological measurements also referred to as biometric measurements.

Traditionally, password/PIN-based or single factor authentication and security systems have been predominantly used. A single or first factor authentication method used in online banking environments, ecommerce, mobile commerce, corporate intranets, enterprise web-mails, etc are recognized today to be inadequate for online transactions. Single-factor authentication is particularly vulnerable to offline credential-stealing and online channel-breaking attacks.

Of late various banks worldwide have started implementing ‘tokens’ or something that the user has as a second factor for secure authentication. This is deployed as a combination of two factors, wherein a user attempting to logon to the bank is required to enter his username or account number along with his password. In addition, the user is also asked to enter a code that is generated by the token. The code generated is in accordance with predetermined methods and is dependent on the token itself. Thus each token will generate a random code that is unique to it. The code generated is based either on system time or a monotonic counter (i.e. a constantly increasing/decreasing counter) or any combination thereof. Thus a code may be generated on the basis of a unique identifier or encryption key stored in the token and the system time ensuring that the code generated would change with time, but would remain unique to the token from which it is generated. Similarly, a onetime code may also be generated on the basis of a unique identifier or encryption key stored in the token and a monotonic counter ensuring that the code generated would change every time, but would remain unique to the token from which it is generated.

Tokens as second factor authentication are increasing in popularity with a large number of organizations implementing greater security and more accurate authentication requirements for their systems.

However, though second factor authentication systems have been effective against offline credential stealing attacks, esp. instances of phishing and pharming attacks, they has been found to be inadequate to counter the more sophisticated man in the middle or channel breaking attacks. Security vendors have adopted various piecemeal strategies from mutual authentication mechanisms to challenge response communications, but have not been able to effectively mitigate all risks related to man in the middle and similar forms of channel breaking attacks.

A man in the middle or channel breaking attack refers to the interception of communication between a user and a service or entity. For example, a transaction to between a customer and a bank may be intercepted by a man in the middle application that would represent itself as the bank to the customer and pass on information collected from customer to the bank, such that both bank and customer are led to believe that a secure and authentic transaction is being carried out. This interception and subsequent passing on of information enables the channel breaking application to alter or store information leading to serious consequences. Thus the channel breaking application may alter financial transaction information without the knowledge of the bank or customer. The channel breaking application may also lead the customer to believe that he has logged off while instructing the bank to carry out unauthorized transactions.

The channel breaking application typically rests on the users computing device and is capable of capturing and relaying personal information to an unauthorized party. The channel breaking application may however also be online or on the service providers system.

There is therefore a requirement for a secure and reliable authentication mechanism that effectively counters channel breaking and other such attacks. In particular there is a requirement that such a mechanism be able to ensure financial transaction security even in the presence of channel breaking attacks. There is also a requirement that such a mechanism be easy to use for the consumer and easy to deploy for the entity seeking financial transaction security.

### SUMMARY

The invention relates to a method of authentication for a provider comprising requesting a verification system for authentication of a transaction initiated by a user by transmitting to the verification system details of the transaction initiated; requesting the user to authenticate the transaction on a mobile device by transmitting to the user mobile device details of the transaction; validating the authentication request received from the verification system on the mobile device and prompting the user to enter a personal identification number; displaying to the user transaction details on receiving a valid personal identification number and requesting user to authenticate transaction; generating on receiving user authentication an authentication parameter for transmission to the verification system; and authenticating the transaction to the provider on receiving a valid authentication parameter from user mobile device.

The invention also relates to an authentication module for a verification system, the verification system capable of authenticating a transaction on receiving an authentication request from a provider for a transaction initiated by a user and transmitting to an authentication module on a user mobile device a request for authentication; the authentication module comprising a request verifier to validate the verification system; a PIN prompter to query the user for a PIN on receiving a confirmation from the request verifier; a display module for displaying transaction details on the user mobile device on receiving a confirmation from the PIN prompter; and an authentication parameter generator for generating an authentication parameter for transmission to verification system on receiving an authentication from user.

### BRIEF DESCRIPTION OF ACCOMPANYING DRAWINGS

The accompanying drawings illustrate the preferred embodiments of the invention and together with the following detailed description serve to explain the principles of the invention.

FIG. 1 is a schematic illustration of the method for remote and second factor authentication in accordance with an embodiment.

FIG. 2 illustrates the verification system verifying multiple users and connected to multiple service providers in accordance with an embodiment.

FIG. 3 illustrates a detailed overview of the verification system in accordance with an embodiment.

FIG. 4 illustrates the authentication module residing on a user mobile device.

### DETAILED DESCRIPTION OF PREFERRED EMBODIMENTS

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

A security and authentication method and system for verification of a transaction initiated by a user at a provider is described. The method requires an authentication code as second factor authentication on a channel other than the channel employed for the verification of the first factor authentication. The method and system is capable of implementation for various providers including entities such as banks, institutions, vendors and merchants. A method and system for secure and efficient remote authentication is also provided. The method and system as taught herein do not require a plurality of code generation applications or tokens for a user to authenticate a transaction at a plurality of entities. Moreover, the entities such as banks, institutions, vendors and merchants do not require an independent second factor verification or remote verification capability.

The invention relates to a simple and efficient security and authentication method and system for verification of an authentication code that overcomes channel breaking attacks, improves user friendliness and convenience while enhancing security and reliability of the transaction authorization.

In a second factor or remote authentication environment, a user of a web service, ecommerce portal, mobile commerce or any online transaction, is required to submit his username/account number and a corresponding password or personal identification number. As a second factor or remote authentication the user is also required to submit an authentication code generated by a code generation application. Conventionally this authentication code is submitted over the same channel over which the first factor authentication is carried out. Thus a user submits both first and second or remote factor authentication information in a single online transaction. As such a method of submitting authentication information is susceptible to channel breaking attacks the method and system as described herein provide for submitting the second factor authentication or the remote authentication information on a channel other than the channel employed for the first factor authentication.

The authentication system allows a user to remotely authenticate a transaction by submitting a second factor authentication code on a mobile channel which is different from the channel employed for authenticating the first factor. The authentication system allows a user to remotely authenticate transactions for various entities by submitting a second factor authentication code on a mobile channel, which is different from the channel employed for authenticating the first factor, without requiring each entity to have second factor authentication capability or requiring the user to have multiple second factor code generation applications or tokens. A single verification system is used to verify a user at multiple organizations. Each organization passes on the second factor authentication or the remote authentication to the common verification system.

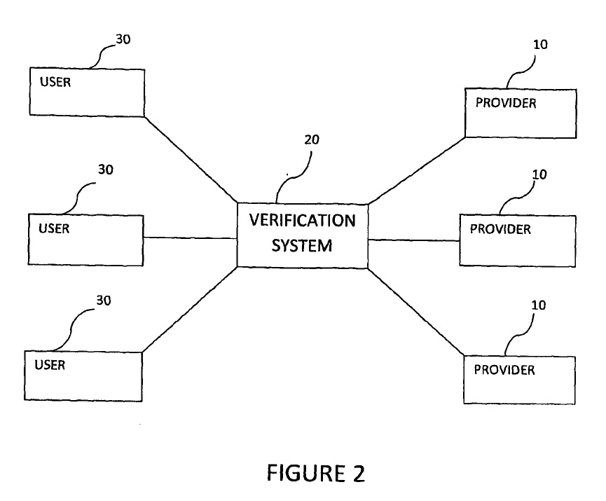

As illustrated in FIG. 2, a verification system (20) is connected to a plurality of service providers (10) and a plurality of users (30). A single user (30) can be remotely authenticated for each of the providers (10) by the verification system. Each provider (10) can also remotely authenticate on an independent channel multiple users (30) by using the verification system (20).

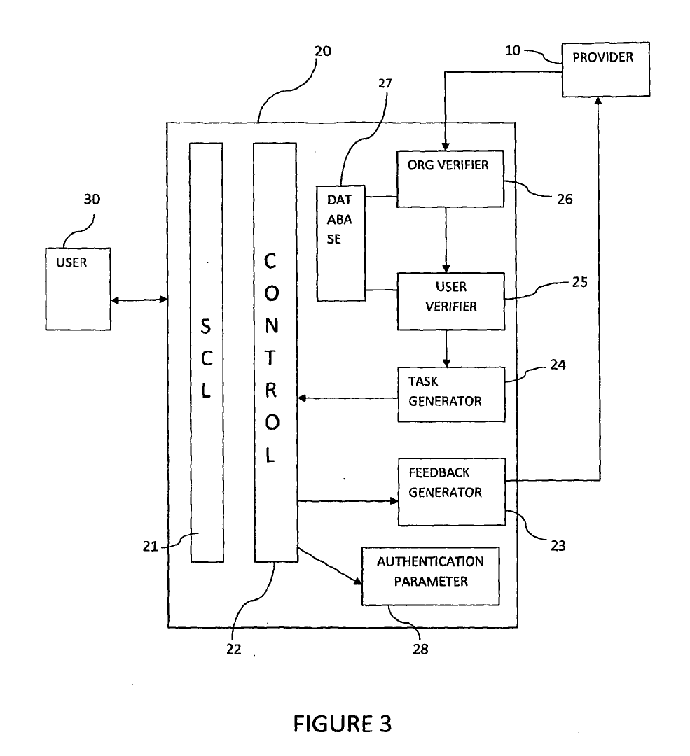

FIG. 3 illustrates a detailed view of the significant elements of the verification system (20). The verification system (20) comprises of an authentication parameter generator (28), a database (27) an organization verifier (26), a user verifier (25), a task generator (24) a feedback generator (23), a control unit (22) and a secure communication layer (21). The verification system (20) is connected to at least one user (30) and at least one provider (10). The organization verifier (26) receives the authentication request from a provider and verifiers the provider by checking the database (27). The user for which authentication is requested is verified by the user verifier (25) that looks up database (27) to identify the mobile device associated with the user for the requesting provider. On a successful organization and user verification, the task generator (24) forms a request that is transmitted to the user mobile device through the secure communication layer (21). On receiving a response and authentication parameter from the user mobile device, the control (22) verifies the authentication parameter received with the authentication parameter generator (28). If the authentication parameter received is valid, the transaction is authenticated by the feedback generator (23) to the provider (10).

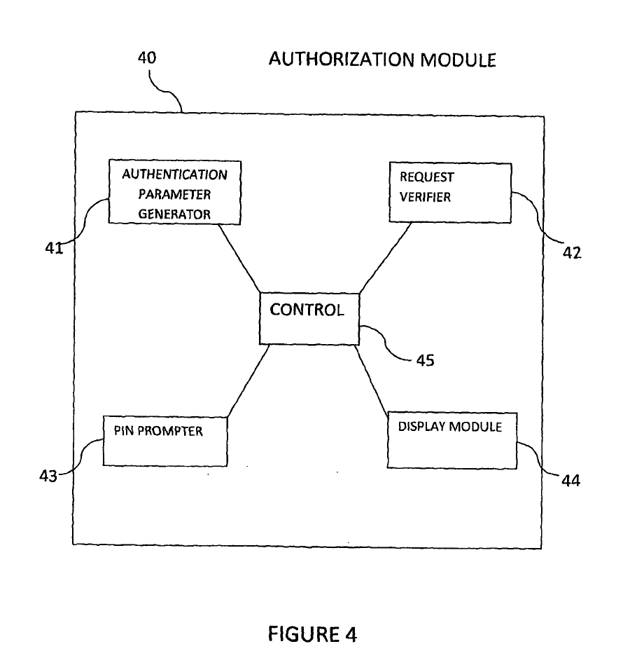

With reference to FIG. 4, the authentication module (40) residing on a user mobile device is illustrated. The authentication module comprises of a control (45), a display module (44), a PIN prompter (43), a request verifier (42) and an authentication parameter generator (41). On receiving an authorization request along with transaction details from a verification system, the control (45) directs the request verifier (42) to validate the requester. On receiving a confirmation from the request verifier (42) the PIN prompter (43) prompts the user to enter a PIN. On receiving a valid PIN from the user, the PIN to prompter confirms user to the display module (44). The display module extracts transaction details from the authentication request received and displays the details on user mobile device for authentication. On receiving an authentication confirmation from the user, the control (45) directs the authentication parameter generator (41) to generate an authentication parameter which the control (45) transmits back to the verification system.

Verification of the requester may be done by combination of a session key exchanged during user activation and a message authentication code MAC which is appended to the message by the server which is checked against the MAC calculated by the authorization module using a key shared during user activation

The authorization parameter may for example be a onetime passcode as generated by conventional code generation “token” devices or applications. The code generation application generates a unique and random one-time-use code, based on an encryption key stored in the application and a monotonic counter, when a valid PIN is received. The one-time-use code so generated is submitted for validation to the verification system by transmission of the same from the mobile device. The verification system validates the one-time-use code with an expected value based on the encryption key stored in the application or token and other predetermined factors (i.e. expected value of the counter in the application). The verification system sends a transaction authorization to the provider if the match is successful.

To enhance security the user is provided with the transaction details for which authorization is requested, so that the user can check the exact details of the transaction that are being authorized. The provision of displaying to the user the transaction details on an independent channel overcomes the limitation of man in the middle attacks as any alteration in the transaction parameters would be noticed by the user. To further enhance security, the authorization module resident on the user mobile device first verifies the sender details to ensure that the authorization request received has originated from a valid source. This validation of authorization requester is done before the authorization request is displayed to the user.

To enhance user friendliness, the authorization request is “pushed” on the user mobile device, such that on receiving an authorization request that has been validated, the authorization module prompts the user for a personal identification number [PIN]. A PIN is a user maintained input secret entry, such as an alphanumeric string that is used as an intermediate parameter on the authentication module for access to the authentication module and generation of the authentication parameter for a transaction. The user enters the PIN into the authentication module whenever an authorization request is received by the mobile device and the sender of the authorization request is verified by the authentication module. The PIN is a highly secure piece of information in the sense that it is never transmitted along the authentication message during the transaction by the mobile phone. It is only known by the user and the authentication module and is not known or maintained by any third party. The PIN may be a long alphanumeric string or a shot alphanumeric string such as a 4 digit number. Preferably the PIN is issued to the user when the user registers at the verification system. The PIN may however be changed at any time by the user. In accordance with an aspect the PIN may also be generated using a biometric device such as a fingerprint sensor.

On receiving a valid PIN from the user the authorization module extracts the transaction details from the request received and displays the transaction details on the mobile device for user authentication. The user is required to either authorize or cancel the transaction. On receiving an authorization response from the user the authorization module of the mobile device automatically generates an authentication parameter for transmission to the verification system.

The receipt of the authentication parameter from the mobile device indicates that a valid request was received by the mobile device and that the user has validated himself and authorized the transaction.

The transaction details and authorization request are received by an authorization module that resides on the mobile device. On receiving the request from the verification system the authorization module is automatically invoked and it carries out verification of requester.

On a successful verification of the sender the authorization module next prompts the user to enter a PIN to authenticate himself. If a valid PIN is entered by the user the authorization module next displays the transaction parameters to the user and requests the user to either authorize or decline. The authorization or decline can be implemented by entering a single key on the user mobile device. If an authorization decision is entered by the user the authorization module automatically generates an authorization parameter for transmission to the verification system. This authorization parameter is then automatically transmitted to the verification system by the authorization module.

By automatically carrying out sender verification, and OTP generation and transmission the user friendliness and convenience is greatly increased. The automatic invocation of the authorization module on receiving an auth request also greatly enhances user convenience. Moreover, the user is able to see the details of the transaction that are being authorized by him before authorizing it. The user is only required to enter the PIN and indicate whether the transaction is to be authorized or declined. This simple auth process for the user does not compromise on the transaction security.

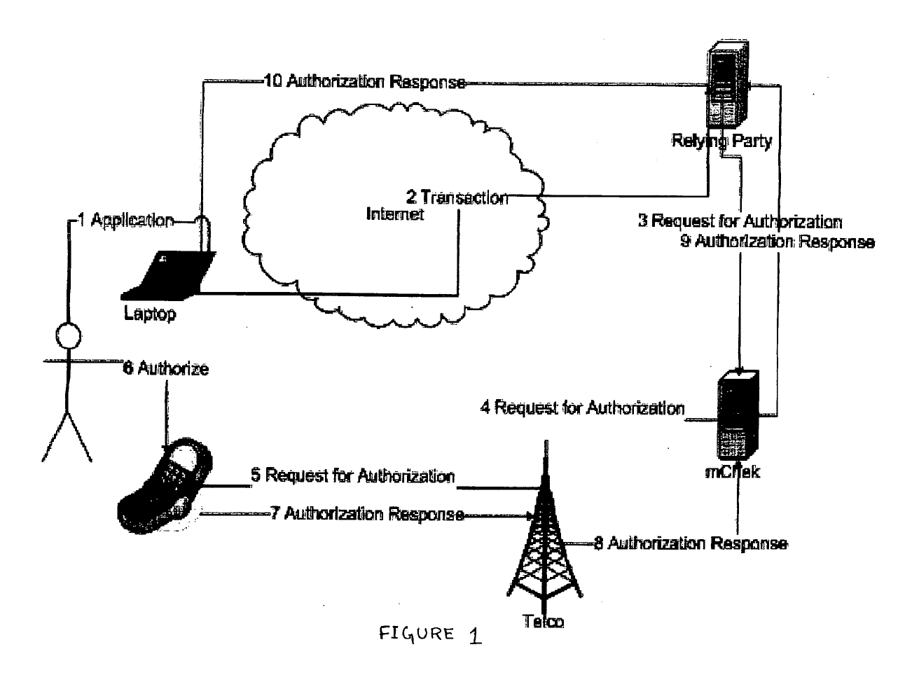

With reference to FIG. 1, a user is authorized at a bank or any other entity in a conventional manner by submitting his first factor authentication (1). On receiving user instructions to carry out a particular transaction the bank, or when the provider requires remote authentication or second factor authentication, sends user and transaction information to a verification system (2). The verification system determines a mobile device associated with the user and uses a mobile channel to request the user to authorize the transaction (3). The verification system sends the transaction details to the user for verifying. On receiving a verified request the user enters a PIN and authorizes or declines a transaction (4). On receiving authorization from user, the transaction is authorized by the verification system to the provider (5). A successful verification may be intimated to the user on the first channel. The user authorizes a transaction on a second channel based on the transaction parameters that he has entered on the channel that he used to initiate the transaction, and is thus sure of what is being authorized.

In accordance with an embodiment the transaction may be time based in that failure to provide second factor authentication to the bank or verification system within a specified time may result in the transaction being cancelled or aborted.

A user of the code generation application submits his one-time-use authentication code to the verification system, when requested, which in turn authenticates the user with an entity or a plurality of entities connected to it, thereby authorizing the transaction. The user is not required to run multiple applications or carry multiple hardware tokens for the multiple entities for which authentication may be required. Moreover, the code generation application is not required to generate multiple one-time-use codes for multiple entities, the same one-time-use code can be used across multiple entities that seek authentication from the single verification system. The verification system is independently hosted and is connected to a plurality of entities, who can request second factor authentication on another channel on an on-demand basis.

A provider registers with the verification system and provides a list of end users to the verification system. The provider instructs end users to download and enable the authorization module on their mobile phones and enable the application.

The method and system of the invention can be implemented on all mobile phones, even the lower end models phones. Moreover, as the second factor authentication takes place on a mobile channel which is different from the channel established between the user and the entity, channel breaking attacks are avoided. The teachings of the invention also require minimal alterations to existing systems for deployment.

It should be noted that the term “transaction” is applicable not only to “financial” transactions but to any transaction involving authentication. For example, without to limitation, Transaction refers not only to transactions such as an online banking login, but also to a company extranet login. It should be applicable to any transaction where the user is being authenticated by some means, regardless of the purpose of the authentication. Without limiting the foregoing, the following list illustrates certain types of transactions it may apply to: (1) Online enrolment, such as financial account opening: banking, brokerage, and insurance; subscriptions for example for ISP, data and informational content deliveries; customer service enrolment; enrolment to Programs (partnership, MLM, beta, etc.) and any other similar type of transaction; (2) Online transactions such as Online Purchasing, B2B, B2c and C2C transactions; Electronic Bill payment; Internet ACH providers; Money transfers between accounts; Online brokerage trading; Online insurance payments; Certain online banking transactions; Tax filing or Any other similar type of transaction; (3) Online Applications such as for credit cards; loans; memberships; patent applications or information; Governmental applications or other similar type of transactions; (4) Online password resetting, as well as online change or update to personal data by re-authentication/re-enrolment; by combining a mechanism involving secret questions; or by a combination of the above; (5) any login to a restricted service, or other operations that involve an element of risk. Other suitable transactions may be included as well.

We claim:

1. A method of authentication for a provider comprising:
a. requesting a verification system for authentication of a transaction initiated by a user by transmitting to the verification system details of the transaction initiated;
b. requesting the user to authenticate the transaction on a mobile device by transmitting to the user mobile device details of the transaction;
c. validating the authentication request received from the verification system on the mobile device and prompting the user to enter a personal identification number;
d. displaying to the user transaction details on receiving a valid personal identification number and requesting user to authenticate transaction;
e. generating on receiving user authentication an authentication parameter for transmission to the verification system; and
f. authenticating the transaction to the provider on receiving a valid authentication parameter from user mobile device.

2. A method of authentication as claimed in claim 1 wherein validating the authentication request includes verification of encryption keys between verification system and mobile device.

3. A method of authentication as claimed in claim 1 wherein the authentication parameter is a onetime use pass code.

4. A method of authentication as claimed in claim 1 wherein the authentication request has a time limit and expires on the completion of the time limit.

5. A method of authentication as claimed in claim 1 wherein the verification system retains records of transactions authenticated for a provider.

6. A method of authentication as claimed in claim 1 wherein a user is registered with the verification system for at least one provider.

7. An authentication module for a verification system, the verification system capable of authenticating a transaction on receiving an authentication request from a provider for a transaction initiated by a user and transmitting to an authentication module on a user mobile device a request for authentication; the authentication module comprising:
a. a request verifier to validate the verification system;
b. a PIN prompter to query the user for a PIN on receiving a confirmation from the request verifier;
c. a display module for displaying transaction details on the user mobile device on receiving a confirmation from the PIN prompter; and
d. an authentication parameter generator for generating an authentication parameter for transmission to verification system on receiving an authentication from user.

8. A system as claimed in claim 7 wherein the verification system includes an organization verifier for verifying a provider on receiving an authentication request from provider.

9. A system as claimed in claim 7 wherein the verification system includes a user verifier module for determining the user mobile device for the user.

10. A system as claimed in claim 7 wherein the verification system includes a task generator for transmitting to the user mobile device request for authentication of a transaction along with transaction details.

11. A method substantially as herein described with reference to and as illustrated by the accompanying drawings.

12. A system substantially as herein described with reference to and as illustrated by the accompanying drawings.
